(19) United States
(12) Patent Application Publication
(10) Pub. No.: US 2002/0154960 A1
(43) Pub. Date: Oct. 24, 2002

(54) Power drill with vacuum dust-collection ability

(76) Inventor: Sheng Chieh Lin, Taipei (TW)

Correspondence Address: RABIN & CHAMPAGNE, PC, 1101 14TH STREET, NW, SUITE 500, WASHINGTON, DC, 20005, US

(21) Appl. No.: 09/837,370

(22) Filed: Apr. 19, 2001

(51) Int. Cl. B23B 45/00

(52) U.S. Cl. 408/67

(57) ABSTRACT

A power drill includes a main body that is divided into a power chamber for mounting a driving motor and a vacuum fan therein and a dust-collecting chamber for mounting a dust-filter therein. A hose is connected to a front inlet of the dust-collecting chamber with a front suction inlet of the hose fixed to a retractable hose holder to closely locate below a bit of the power drill. When the motor is turned on, it drives the bit to drill a hole and the vacuum fan to rotate at the same time to produce a suction force in the dust-collecting chamber, so that any dust produced during the drilling operation is immediately sucked into the dust-collecting chamber via the hose and then trapped in the dust filter that could be removed from the dust-collecting chamber and cleaned for use next time. The retractable hose holder gradually and elastically retracts when the bit drills the hole, so that the suction inlet of the hose is always kept closely below a joint of the bit and the drilled hole to effectively suck any produced dust.

### FIELD OF THE INVENTION

The present invention relates to a power drill, and more particularly to a power drill with vacuum dust-collection ability, so that any dust produced during a drilling operation is sucked into the power drill without scattering to harm an operator's eyes and respiratory tract as well as contaminate a working environment.

### BACKGROUND OF THE INVENTION

A power drill is a common tool widely employed by people in their daily life to drill holes. During the drilling operation, dust is produced to scatter in the working environment, forming a source to harm the operator's eyes and respiratory tract and even to result in some diseases, such as chronic bronchitis.

It is therefore desirable to develop a power drill that could prevent any dust produced during the drilling operation from scattering.

### SUMMARY OF THE INVENTION

A primary object of the present invention is to provide a power drill with vacuum dust-collection ability, so that any dust produced during the drilling operation is effectively collected through vacuum suction provided by the power drill while drilling hole, and the operator is protected from any disease possibly caused by such scattered dust.

To achieve the above and other objects, the present invention provides a power drill that includes a main body being divided into a power chamber for mounting a driving motor and a vacuum fan therein and a dust-collecting chamber for mounting a dust-filter therein. A hose is connected to a front inlet of the dust-collecting chamber with a front suction inlet of the hose fixed to a retractable hose holder so as to closely locate below a bit of the power drill. When the motor is turned on, it drives the bit to drill a hole and the vacuum fan to rotate at the same time to produce a suction force in the dust-collecting chamber, so that any dust produced during the drilling operation is immediately sucked into the dust-collecting chamber via the hose and trapped in the dust filter that could be removed from the dust-collecting chamber and cleaned for use next time. The retractable hose holder is able to gradually and elastically retract when the bit drills the hole, so that the suction inlet of the hose is always kept closely below a joint of the bit and the drilled hole to effectively suck any produced dust.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a power drill with vacuum dust-collection ability according to the present invention;

FIG. 2 is a sectioned side view of the power drill of FIG. 1; and

FIG. 3 is a sectioned side view of the power drill of the present invention in operation.

### DETAILED DESCRIPTION OF THE PREFERRED EMBODIMENTS

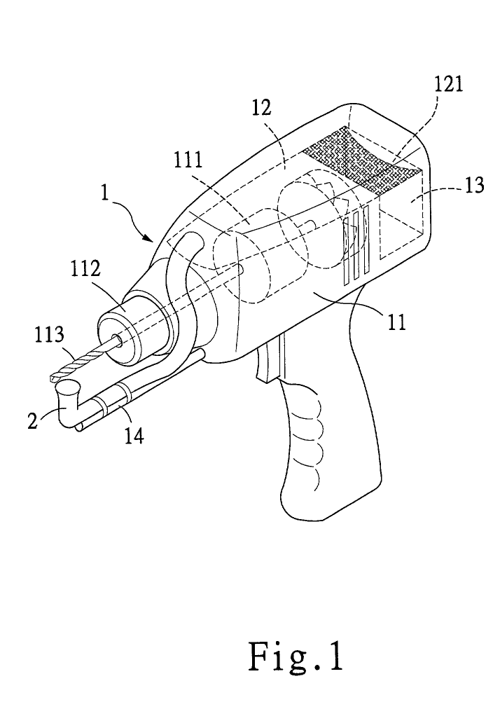

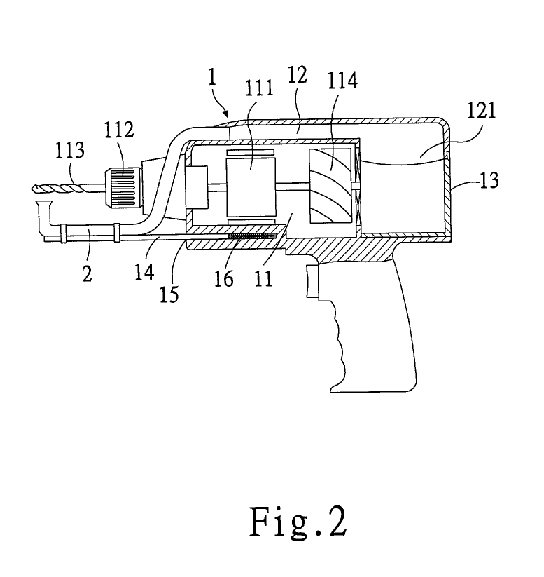

Please refer to FIGS. 1 and 2 that are perspective and sectioned side views, respectively, of a power drill with vacuum dust-collection ability according to the present invention. As shown, the power drill includes a main body 1, an inner space of which is divided into a power chamber 11 and a dust-collecting chamber 12.

In the power chamber 11, there is provided a driving motor 111, a front end of which is connected to a chuck 112 to which a bit 113 is connected, and a rear end of the driving motor 111 is connected to a vacuum fan 114 for producing a suction force.

The dust-collecting chamber 12 is in the shape of a lying letter L to locate above and behind the power chamber 11. The dust-collecting chamber 12 is internally provided at a predetermined position with an opening 121 to which a dust filter 13 is connected for filtering duct-containing air and collecting dust sucked into the dust-collecting chamber 12. The dust-collecting chamber 12 has a front inlet to which a hose 2 is connected.

A long hole 15 is longitudinally provided at a lower front of the main body 1 for receiving a compression spring 16 therein. A rigid and elongated bar serving as a hose holder 14 is inserted into the long hole 15 to press a rear end against the compression spring 16, such that a front end and most part of the hose holder 14 is adjustably projected from the long hole 15. A front portion of the hose 2 extended from the inlet of the dust-collecting chamber 12 is fixedly bound to the hose holder 14 with a suction inlet of the hose 2 turned upward to locate below a front end of the bit 113. When the power drill is operated to drill a hole on a surface (not shown) and the bit 113 is partially extended into the surface, the front end of the hose holder 14 is brought to touch the surface and is subject to a backward pressure applied by the surface to it. At this point, the compression spring 16 is compressed in the long hole 15 to allow the hose holder 14 to partially retract into the long hole 15 by an extent corresponding to a depth by which the bit 113 is extended into the surface. That is, the suction inlet of the hose 2 is always adjustably maintained at a position closely below a joint of the bit 113 and the drilled surface to suck dust produced during the drilling operation into the hose 2.

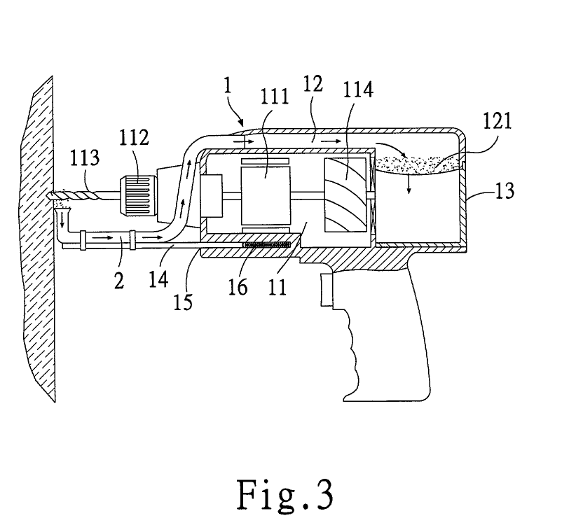

Please now refer to FIG. 3 that shows the power drill of the present invention in operation. To operate the power drill for drilling a hole, the driving motor 111 is turned on to rotate the chuck 112 and the vacuum fan 114 at the same time, so that the vacuum fan 114 produces a suction force to suck any dust produced at the front end of the bit 113 during the drilling operation into the dust-collecting chamber 12 via the hose 2. The dust that is sucked into the chamber 12 is then trapped at the dust filter 13. The dust filter 13 is removable from the dust-collecting chamber 12 via the opening 121 for cleaning. And, the cleaned dust filter 13 maybe replaced into the dust-collecting chamber 12 again for use in a drilling operation next time.

With the elastically retractable hose holder 14, the suction inlet of the hose 2 is always maintained at a position close to where the dust is produced during the drilling operation to effectively prevent scattered dust.

With the above arrangements, the power drill with vacuum dust-collection ability of the present invention protects an operator against harms possibly caused by the scattered dust and is helpful in maintaining a clean working environment.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A power drill with vacuum dust-collection ability, comprising a main body, an inner space of which being divided into a power chamber and a dust-collecting chamber, a driving motor mounted in said power chamber, a vacuum fan located in said power chamber and connected to a rear end of said driving motor, a hose connected at a rear end to a front inlet of said dust-collecting chamber with a front suction inlet of said hose closely located below a tip of a bit outside said main body and rotatably connected to a front end of said driving motor, and a dust filter removably connected to an internal opening provided at a predetermined position in said dust-collecting chamber opposite to said front inlet; whereby when said driving motor is turned on to rotate said bit to drill a hole, said vacuum fan is driven to rotate at the same time to produce a suction force in said dust-collecting chamber, so that any dust produced at the tip of said bit during drilling hole is immediately sucked into said dust-collecting chamber via said host and then trapped at said dust filter that could then be removed from said dust-collecting chamber and cleaned for use next time.

2. The power drill with vacuum dust-collection ability as claimed in claim 1, further comprising a hose holder retractably mounted to a lower front portion of said main body for said hose holder to fixedly bind thereto, such that said hose holder gradually and elastically retracts when said bit drills a hole and thereby always keeps said suction inlet of said hose closely below a joint of said bit and said drilled hole.

3. The power drill with vacuum dust-collection ability as claimed in claim 2, wherein said main body is provided at the lower front portion with a longitudinally extended long hole in which a compression spring is received, and said hose holder is inserted into said long hole to press against said compression spring with a front end and most part of said hose holder projected from said long hole for said hose to bind thereto.
